(19) United States
(12) Patent Application Publication
(10) Pub. No.: US 2011/0275428 A1
(43) Pub. Date: Nov. 10, 2011

(54) SYSTEM AND METHOD FOR USING A PLAYER'S PICTURE AS A SYMBOL OR DAUBER ON A SLOT GAME OR GAMING MACHINE BEING PLAYED INSTANTANEOUSLY

(76) Inventors: David S. Forman, Rancho Mirage, CA (US); Rick White, Rancho Mirage, CA (US)

(21) Appl. No.: 12/822,418

(22) Filed: Jun. 24, 2010

Related U.S. Application Data
(60) Provisional application No. 61/331,313, filed on May 4, 2010.

(51) Int. Cl. A63F 9/24; A63F 13/00

(52) U.S. Cl. 463/16; 463/30; 463/43

(57) ABSTRACT

Generally described, the present application relates to gambling, and more particularly, to a gaming machine that provides a more personal appeal so that a player's interest is kept. In one illustrative embodiment, the gaming machine can include a camera for taking a picture of a player that is at or proximate the gaming machine. The gaming machine can store the picture as an art file. When played, a gaming presentation can locate the art file and display the player's picture within a game on the gaming machine. The player's picture can replace one of many symbols within the game. The picture can also be placed on playing chips or the background of the game. In slot machines, the reels can include the player's picture uploaded from the art file. The player's picture can also be a daub on a bingo game or a face on a playing card.

### REFERENCE TO RELATED APPLICATIONS

This application claims priority to U.S. Provisional Application Ser. No. 61/331,313 titled SYSTEM AND METHOD FOR USING A PLAYER'S PICTURE AS A SYMBOL OR DAUBER ON THE SLOT GAME OR GAMING MACHINE BEING PLAYED INSTANTANEOUSLY that was filed on May 4, 2010 by David Forman and is hereby incorporated in its entirety.

### TECHNICAL FIELD

The application generally relates to gambling, and more particularly, to the aesthetic look of gaming machines where the player's picture can be taken at the time of play and instantly placed within a gaming presentation displayed on the machine.

### BACKGROUND

Originally, slot machines were provided as a diversion for casual garners. Unlike traditional table games, slot machines did not require any gambling knowledge, and anyone could get in the game with a very small bet. Slot machines eventually moved off the sidelines to become the most popular and the most profitable game, often bringing in more than sixty (60) percent of annual gaming profits in the United States.

The technology of slot machines has changed quite a bit over the years. For example, the classic mechanical slot machine with reels has been almost completely replaced by computer-controlled machines. Through these upgraded machines, other table games were introduced into casinos including poker, bingo, roulette, etc. The machines often allowed players to modify bets and preferences without the strict protocol found at tables. These games were often set to a theme and included flashing lights and sounds to attract players.

But lately, these games have become stagnant and provide little user interaction besides pressing buttons or pulling levers. From a slot player's point of view, the player pulls the handle and the three reels start spinning. If all three display the right symbol, the player wins. This process is repeated until boredom sets in. Similar processes can be said of other casino games.

Currently, machines do not provide the aesthetic look to draw in and retain customers. Going to any casino these days, noticeably, a number of these machines are empty. Therefore, what is needed is a gaming machine that provides a more personal touch and flavor so that a player's interest can be kept. The present application addresses these concerns in prior art gaming machines and provides other, related advantages.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a computer-implemented method on a gaming machine for presenting a player's image in a gaming presentation is provided. The method can include receiving the player's image. In addition, the method can include storing the player's image within an image file on the gaming machine. The method can also include displaying the player's image stored within the image file at locations pointed to by the gaming presentation on the gaming machine.

In accordance with another aspect of the present application, a gaming device is provided. The gaming device can include a camera, an input device, a display screen, at least one processor, and a memory operatively coupled to the processor, the memory storing program instructions that when executed by the processor, causes the processor to perform processes. The processes can include capturing a user's image through the camera. In addition, the processes can include displaying the user's image within a casino-type game on the display screen.

In accordance with yet another aspect of the present application, a method of dynamically enhancing a casino game is provided. The method can include identifying whether a player is within a defined area of the casino game. In addition, the method can include taking a picture of the player when the player is within the defined area. The method can also include storing the picture within a vector art file. The method can include displaying the casino game that points to the vector art file for filling in portions of the casino game with the picture.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is a block diagram showing exemplary components within a gaming machine in accordance with one aspect of the present application;

FIG. 2A depicts a flow chart illustrating processes for retrieving an image and displaying that image on a gaming machine in accordance with one aspect of the present application;

FIG. 2B is a flow chart showing exemplary processes for retrieving an image in accordance with one aspect of the present application;

FIG. 2C shows a flow chart illustrating processes for taking an image in accordance with one aspect of the present application;

FIG. 2D depicts a flow chart representing exemplary processes for filling in retrieved images in accordance with one aspect of the present application;

FIG. 3A is an exemplary screen shot showing the captured image within a slot machine in accordance with one aspect of the present application;

FIG. 3B shows an exemplary screen shot that provides the captured image within another slot machine in accordance with one aspect of the present application;

FIG. 4 shows an exemplary screen shot providing the captured image as a dauber in accordance with one aspect of the present application; and

FIG. 5 depicts a screen shot illustrating an exemplary card game showing the captured image in accordance with one aspect of the present application.

### DESCRIPTION OF THE APPLICATION

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

### Overview

Generally described, the present application relates to gambling, and more particularly, to a gaming machine that provides a more personal appeal so that a player's interest is kept. In one illustrative embodiment, the gaming machine can include a camera for taking a picture of a player that is at or proximate the gaming machine. The gaming machine can store the picture in an art file. When played, a gaming presentation can locate the art file and display the player's picture within a game on the gaining machine. The player's picture can replace one of many symbols within the game. In slot machines, the reels can include the player's picture uploaded from the art file. The player's picture can also be a daub on a bingo game or a face on a playing card. The picture can also be placed on playing chips or the background of the game.

As will become apparent, the gaming machine provided herein can increase user participation. Through the camera, the player can take pictures of themselves or other parties and alter those pictures. In one embodiment, the players can animate their pictures. Numerous other options can be provided so that players can create an interface that they find stimulating. Other benefits will become apparent from the description provided below.

The embodiment provided above represents one illustration. It should not be construed as the only embodiment. Known to those skilled in the relevant art, the player's picture can be provided in numerous types of games. Gaming machines can interact with the user through a video display or reels common on typical slot machines. It should be understood that the concepts provided within the present application can be applied to numerous platforms, one of which will be described below.

### Gaming Machine

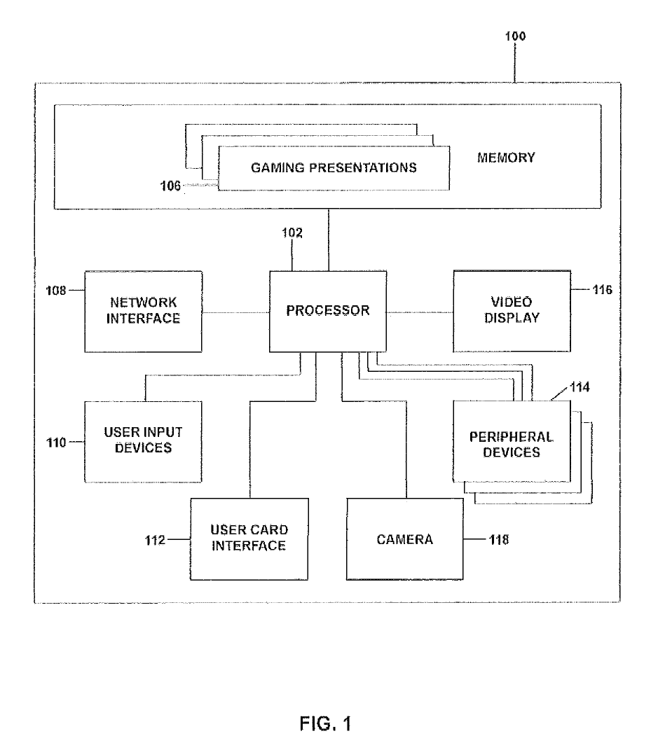

FIG. 1 is a block diagram showing exemplary components within a gaming machine 100 in accordance with one aspect of the present application. Typically, the gaming machine 100 can include a memory 104 operable to store one or more gaming presentations 106, a network interface 108, user input devices 110, a user card interface 112, peripheral devices 114, a video display 116, and a camera 118, all of which can be connected to processor 102. In one embodiment, the gaming machine 100 can be a class 2 gaming device. Features and functions provided within the present application, however, can be adapted to other types of devices where games are played, for example, a gaming console. The components described herein are exemplary and should not be construed as limiting to the present application. Those skilled in the relevant art will appreciate that the gaming machine 100 can be provided in numerous configurations and implementations with fewer or more components.

The gaming presentations 106 stored within the memory 104 can provide many types of games. The games can include, but are not limited to, pachinko, slots, lottery, poker, bingo, keno, etc. Within the games can be a number of symbols, backgrounds, graphics, etc. that can be replaced with the player's picture. Memory 104 can store the player's picture within a vector art file or image file so that the gaming presentations 106 can retrieve the picture for display. In operation, the gaming presentations 106 can request the symbols, backgrounds, graphics from the vector art file during execution. This often removes the need for recompiling the gaming presentation 106. The player's picture can then be placed within the games.

While FIG. 1 shows numerous gaming presentations 106 on the gaming machine 100, a single game can be provided. For example, some gaming machines 100 are dedicated solely as slot machines. Other gaming machines 100 can be directed to only poker machines. Furthermore, and within the scope of the present application, the gaming machine 100 can incorporate other types of games besides those capable of only being displayed on a video display 116. For example, and common within slot machines, a number of reels are presented with a number of images on each reel. The number of reels can vary from each gaming machine 100. When the player's picture is received, it can be placed on the reels of the slot machine 100.

The gaming machine 100 can also include a network interface 108 operable to download one or more gaming presentations 106 from one or more gaming servers and to otherwise communicate with networked devices and servers for various purposes. The gaming machine 100 can further include a video display 116 through which gaming presentations are presented to the user. Gaming machine 100 can further include user input devices 110, such as a keyboard which can be used to enter a pin number or for the selection of various options, various player selectable buttons including bet one, bet all and the like, as well as a touch screen which can be incorporated with video display 116.

The gaming machine 100 can also include a user card interface 112, which is operable to accept a player card that identifies a user as a casino patron to the gaming environment. In one embodiment, a player's picture can be taken at another location and stored with the player data associated with a player club card. As will be shown below, the picture can be used by the gaming presentations 106. The gaming machine 100 can allow for the image to be stored on the player card for use within the game. In another embodiment, the image can be stored in a database and be associated with the player card.

The gaming machine 100 can further include one or more peripheral devices 114, such as a bill/ticket acceptor, ticket printer, and various other devices. In one embodiment, the peripheral devices 114 can be connected to an outside camera source for retrieving the player's picture. Known in the relevant art, there are a number of ways to retrieve pictures of a player, for example, when the player's identification is checked or through security cameras associated with a casino.

As shown in FIG. 1, a camera 118 can be provided by the gaining machine 100. The camera 118 can digitally scan in a picture of the player. As will be shown below, the gaming machine 100 can then use the picture as one of the gaming symbols on many types of games. For example, the picture can be used on the reels of a slot machine or as a dauber on a bingo device. Once the gaming device has processed the picture, the game being played on the device would then quickly change one or more of the reels to reflect the player picture. The camera 118 can be located internally or outside the machine 100.

In one embodiment, the camera 118 can record motions of the player. The motions can then be provided within the gaming presentations 106. A video recorder can also be used to take a video of the player and then provide it in one of the gaming presentations 106. For example, when a selected card is displayed, the video would be played. Numerous other types of image taking devices can be used. In one embodiment, the gaming machine 100 can record the player's voice or other sound to enhance the player's gaming experience.

The gaming machine 100 can also include a processor 102, which can implement the programming logic of the gaming presentations 106 and control the operation of various hardware and software components of the gaming machine, as well as, one or more peripheral devices 114. Game play can begin in response to a player's input to initiate play and the placement of a wager. The processor 102 can be configured to retrieve the requested gaming presentation 106 from memory 104 and display the player's picture within the game. In the case of slots, for example, mechanical or simulated slot reels can be rotated and stopped to display the player's picture on the reels in visual association with one or more pay lines. If the selected outcome is one of the winning outcomes defined by a pay table, the processor 102 can be configured to award the player with a number of credits associated with the winning outcome. In such gaming machines 100, a player can wager multiple credits on one or more lines depending upon the programming or physical limitations of the gaming machine.

### Game Play

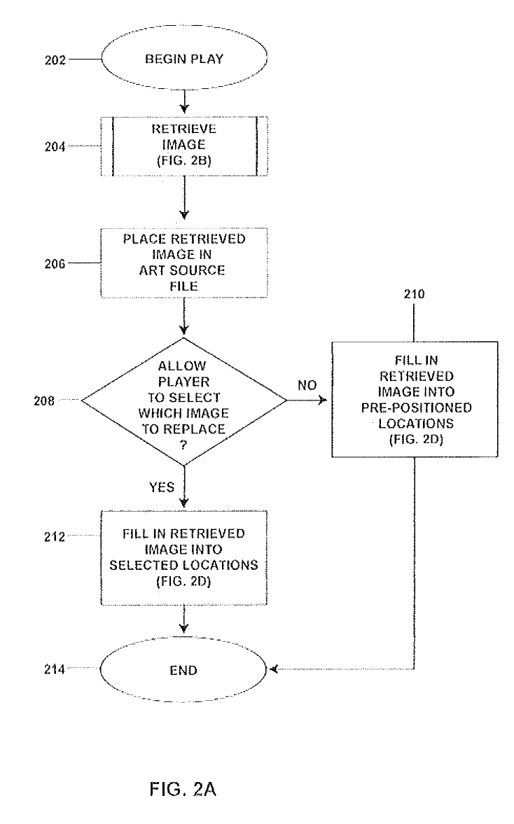

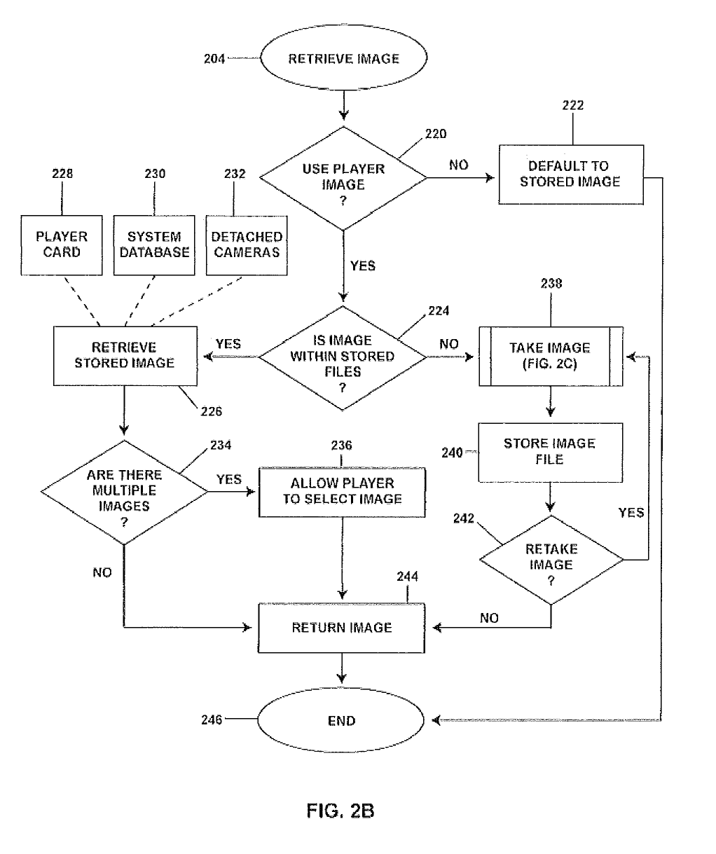

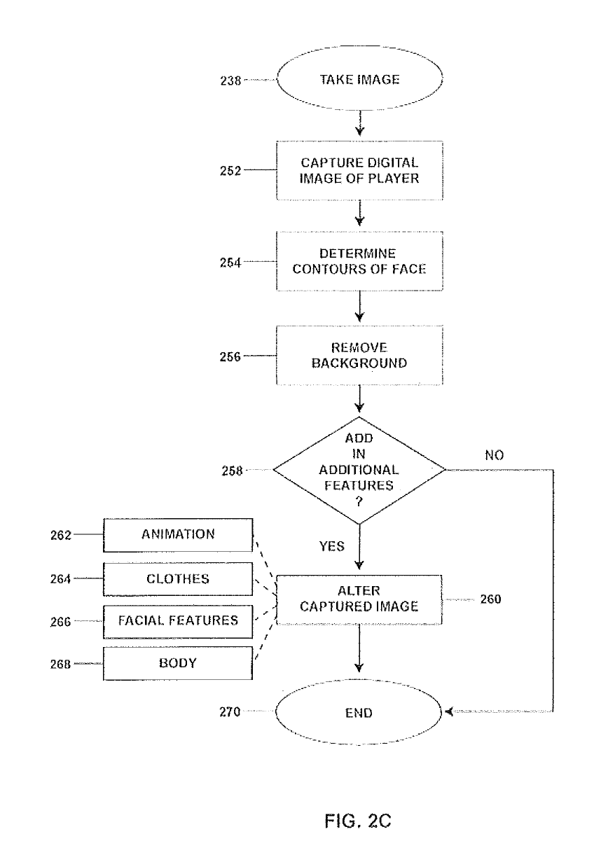

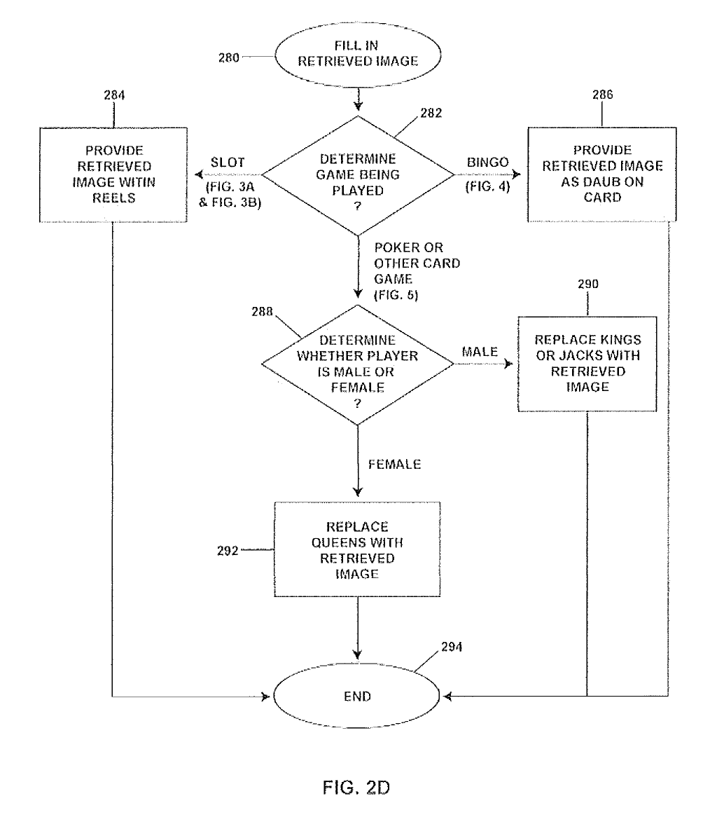

During game play, or before, the player can upload their picture into the gaming machine 100. FIG. 2A depicts a flow chart illustrating processes for retrieving an image and displaying that image on a gaming machine 100 in accordance with one aspect of the present application. The flow chart represents one embodiment, but should not be construed as the only embodiment. Fewer or additional processes can be used. The gaming machine 100 can call for the image file to be identified and then replaced when the player selects that option for the game. The processes can begin at block 202.

At block 204, an image of the player can be retrieved. It should be noted that the terms image and picture can be interchanged. In addition, the terms can also include videos or animations. FIG. 2B is a flow chart showing exemplary processes for retrieving an image in accordance with one aspect of the present application. This represents one subroutine, but other routines known in the relevant art can be used to retrieve the player's picture.

At decision block 220, the gaming machine 100 can determine whether the player wishes to use their image. This option allows the player to retain their privacy. The player can also simply not be interested in the additional features. When the player decides not to use their image, the gaming presentation 106 can use the default image at block 222. The processes can end at block 246 and return to FIG. 2A.

When the user decides to take advantage of these capabilities, however, the gaming machine 100 can determine whether an image file has been stored that relates to the player's picture at decision block 224. Turning first to when the player's image is already stored and the player does not wish to retake their image, the gaming machine 100 can retrieve the stored image at block 226. The image can be stored or pulled from a variety of locations. In one embodiment, the player's image can be taken from a player card at block 228. The player card can be inserted by the player into the user card interface 112. The processor, in this embodiment, can simply read the player card in the user card interface 112 and retrieve the picture of the player. Typically, the player's picture can be stored within a casino database and can be accessed through the network interface 108. In other embodiments, the player's picture can be stored on the player card.

At block 230, the player's picture can be stored within a system database. The system database can be accessed through the network interface 108. Typically, the player can type in identifying information before they can access their picture. In another embodiment, the system database can be local to the gaming machine 100 so that no network interface 108 would be accessed.

Detached cameras can also be used to provide the player's picture at block 232. Detached cameras, in one embodiment, can refer to those cameras not associated directly with the gaming machine 100. The cameras can include security cameras. Generally, casino cameras can provide enough details of the player so that those images can be used within the gaming presentation 106. In one embodiment, the player's picture can be received from the player's driver's license. Those embodiments for retrieving the stored image above are for purposes of illustration. There are numerous types of embodiments for capturing the player's picture known to those skilled in the relevant art.

At decision block 234, the gaming machine 100 can determine whether there are multiple images of the player. The gaming machine 100 can allow the player to select an image from the multiple images at block 236. Typically, the images can be displayed on the video display 116. The selected image, or if there is only one image, can be returned at block 244 to the gaming presentation 106. The processes can end at block 246 and then return to FIG. 2A.

Returning to decision block 224, and when the player wants a new image or there is no image stored, the gaming machine 100 can take an image of the player at block 238. FIG. 2C shows a flow chart illustrating processes for taking an image in accordance with one aspect of the present application. The processes can begin at block 252 where the gaming machine 100 captures a digital image of the player.

In one embodiment, the player has the option to not alter the picture. Alternatively, and at block 254, the contours of the player's face can be determined. The background can be removed at block 256 by using the contours so that the player's picture can be altered. The alterations can provide the player with the ability to add in numerous features that enhance the player's appearance. By removing the background, the player's picture can be simply pasted on predetermined bodies within the gaming presentations 106.

At decision block 258, the gaming machine 100 can determine whether the player wants to add in additional features to the player's picture. When the player decides not to add in additional features the processes can end at block 270 and return to FIG. 2B.

At block 260 and when the user decides to add in additional features, the player can alter their picture through a variety of ways including using the user input devices 110 and if available, a touch screen display 116. In one embodiment, the player can animate themselves as shown at block 262. The gaming machine 100 can animate the picture or image to create movement of the image within the confines or storyboard of the game after it becomes integrated into the game logic. The player can also adjust their clothes or put on comical accessories at block 264. At block 266, the player can adjust their facial features. For example, the player can add in facial hair or a hat. At block 268, the user can adjust their body such as stretching their legs or arms.

Those features provided above represent a small sample of how the player's picture can be altered. Known to those skilled in the relevant art, the player can alter the captured image through a number of ways not described herein. In addition, the captured image can be altered at any time and is not limited to altering images after being captured. For example, stored images can be manipulated. The processes can end at block 270 and return to FIG. 2B.

At block 240 of FIG. 2B, the gaining machine can store the image once it has been taken. Generally, the image is stored in a vector art file so that it can be readily accessed by the gaming presentations 106. The player can store it within the machine or connect to a database and store the image there. The benefit of storing the image in a file is so that it does not have to be compiled during runtime and the images can be dynamically updated.

At decision block 242, the player can determine whether they wish to retake the image. This can be performed before storing the image file to save processing time. When the player wishes to take their image again, the routine at block 238, and further described in FIG. 2C, can be re-executed. The image can be returned at block 244 when the player is satisfied with the taken image. The processes for retrieving the image can then end at block 246 where control is returned back to FIG. 2A.

FIG. 2B represents processes for one illustrative routine to retrieve an image. In the routine, the image was saved to an art source file. When the image has not been saved in the retrieve image routine, that image can be stored within an art source file if not already done so at block 206. At decision block 208, the gaming machine 100 can allow a player to select which images to replace within a game. At block 210, and when the user does not select images to be replaced, the gaming machine 100 can fill in retrieved images into pre-positioned locations. Otherwise, the gaming machine 100 can fill in the retrieved images into selected locations. In one embodiment, the gaining machine 100 does not allow this option at decision block 208.

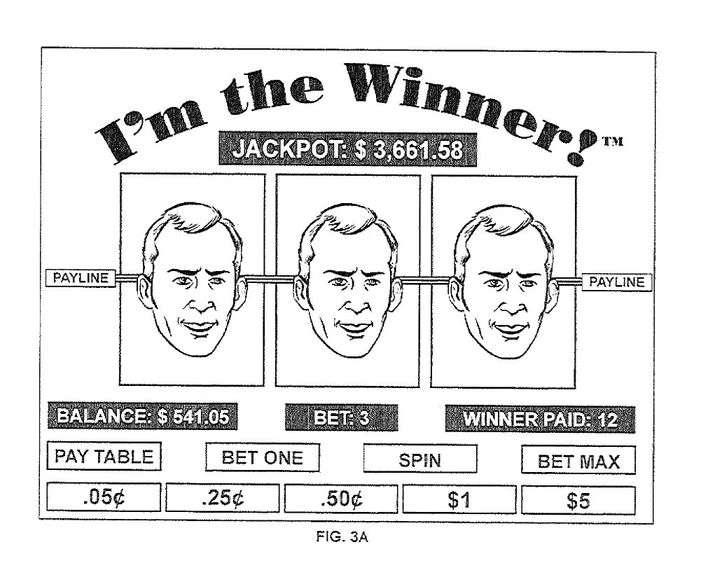

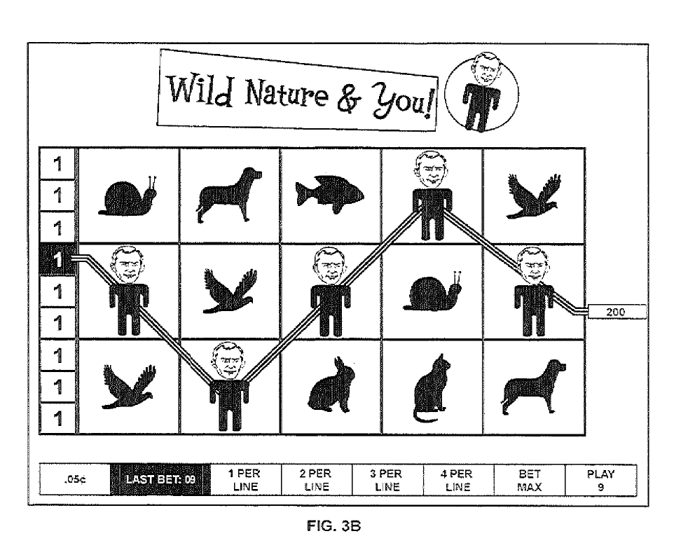

With reference now to FIG. 2D, a flow chart representing exemplary processes for filling in retrieved images in accordance with one aspect of the present application is provided. The processes can start at block 280. At decision block 282, the gaming machine 100 can determine which type of game is being played. At block 284, and when a slot game is being played, the captured image can be used within the reels. An example of this is provided in FIG. 3A. Alternatively, the image can be placed in a video display 116. FIG. 3B shows an exemplary screen shot that provides the captured image within a slot machine in accordance with one aspect of the present application.

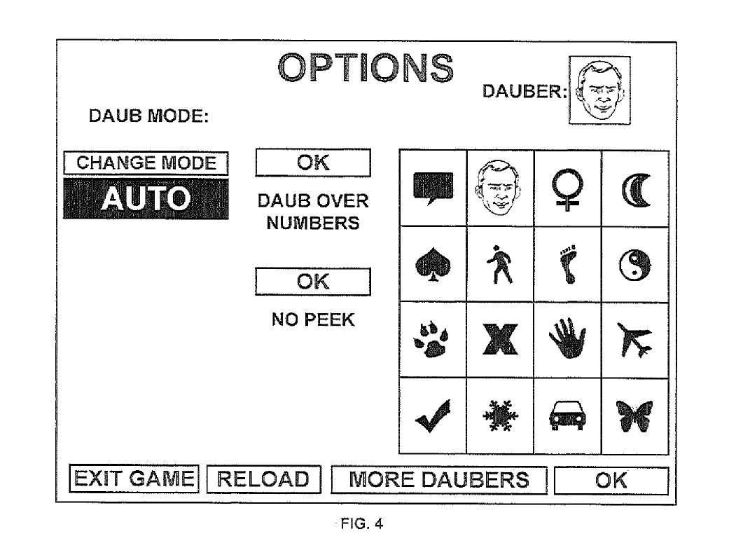

When the player is playing a bingo type game, at block 286, the player's image can be used as a daub on a bingo card. FIG. 4 shows an exemplary screen shot providing the captured image as a dauber in accordance with one aspect of the present application. When a bingo space is called, the player's picture can automatically fill in the specific portion on the card.

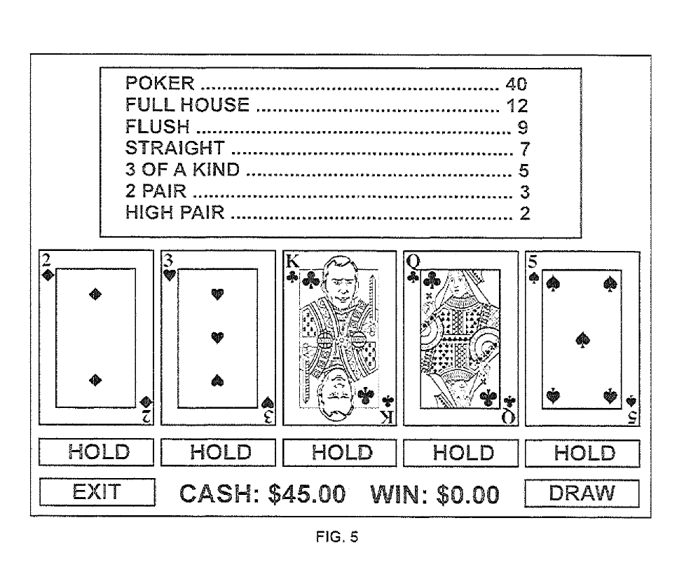

Another embodiment where the player's picture can be used is on a poker or other card game. FIG. 5 depicts a screen shot illustrating an exemplary card game showing the captured image in accordance with one aspect of the present application. In one embodiment, the gaming machine 100, at decision block 288, determines whether the player is male or female. Applications known to those skilled in the relevant art can be used to detect whether the player is male or female. Otherwise, the player can enter in whether they are female or male through the user input devices 110. When the player is male, at block 290, the gaining machine can replace the kings or jacks with the retrieved image. Otherwise, the gaming machine can replace the queen with the retrieve image when female at block 292. The processes can then end at block 294 and return to FIG. 2A.

While a slot, bingo, and poker or other card games have been shown, the player's picture can be replaced with other images in other games. The possibilities shown above are not limiting to the present application. Instead, those embodiments were provided to depict how the player's picture can be inserted into areas where images previously existed. Returning to FIG. 2A, the processes can end at block 214.

### Systems, Methods, and Operations

In accordance with one aspect of the present application, a computer-implemented method on a gaming machine for presenting a player's image in a gaming presentation is provided. The method can include receiving the player's image. In addition, the method can include storing the player's image within an image file on the gaming machine. The method can also include displaying the player's image stored within the image file at locations pointed to by the gaming presentation on the gaming machine.

In one embodiment, receiving the player's image can include retrieving the player's image from a player's card. In one embodiment, receiving the player's image can include retrieving the player's image from a system database. In one embodiment, receiving the player's image can include retrieving the player's image from a detached camera. In one embodiment, receiving the player's image can include capturing the player's image on a camera built within the gaming machine. In one embodiment, the method can include recapturing the player's image when requested.

In one embodiment, the method can include altering the player's image. In one embodiment, altering the player's image can include removing a background of the player's image. In one embodiment, the method can include adding animation to the player's image.

In accordance with another aspect of the present application, a gaming device is provided. The gaming device can include a camera, an input device, a display screen, at least one processor, and a memory operatively coupled to the processor, the memory storing program instructions that when executed by the processor, causes the processor to perform processes. The processes can include capturing a user's image through the camera. In addition, the processes can include displaying the user's image within a casino-type game on the display screen.

In one embodiment, the casino-type game can be a slot game. In one embodiment, the user's image can be displayed on a reel of the slot game. In one embodiment, the casino-type game can be a bingo game. In one embodiment, the casino-type game can be a poker game. In one embodiment, the memory storing program instructions, when executed by the processor, can cause the processor to determine whether the user's image be placed on a king or jack card or a queen card.

In one embodiment, the memory storing program instructions, when executed by the processor, can cause the processor to alter the user's image captured by the camera through modifications received through the input device. In one embodiment, the display screen can include touchpad capabilities.

In accordance with yet another aspect of the present application, a method of dynamically enhancing a casino game is provided. The method can include identifying whether a player is within a defined area of the casino game. In addition, the method can include taking a picture of the player when the player is within the defined area. The method can also include storing the picture within a vector art file. The method can include displaying the casino game that points to the vector art file for filling in portions of the casino game with the picture.

In one embodiment, the casino game can be a slot game and the picture fills in a portion of at least one reel. In one embodiment, the casino game can be a bingo game and the picture is used as a daub.

The foregoing description is provided to enable any person skilled in the relevant art to practice the various embodiments described herein. Various modifications to these embodiments will be readily apparent to those skilled in the relevant art, and generic principles defined herein can be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. On a gaming machine, a computer-implemented method for presenting a player's image in a gaming presentation comprising:
receiving said player's image;
storing said player's image within an image file on said gaming machine; and
displaying said player's image stored within said image file at locations pointed to by said gaining presentation on said gaming machine.

2. The computer-implemented method of claim 1, wherein receiving said player's image comprises retrieving said player's image from a player's card.

3. The computer-implemented method of claim 1, wherein receiving said player's image comprises retrieving said player's image from a system database.

4. The computer-implemented method of claim 1, wherein receiving said player's image comprises retrieving said player's image from a detached camera.

5. The computer-implemented method of claim 1, wherein receiving said player's image comprises capturing said player's image on a camera built within said gaming machine.

6. The computer-implemented method of claim 5, further comprising recapturing said player's image when requested.

7. The computer-implemented method of claim 1, further comprising altering said player's image.

8. The computer-implemented method of claim 7, wherein altering said player's image comprises removing a background of said player's image.

9. The computer-implemented method of claim 1, further comprising adding animation to said player's image.

10. A gaining device comprising:
a camera;
an input device;
a display screen;
at least one processor; and
a memory operatively coupled to said processor, said memory storing program instructions that when executed by said processor, causes said processor to:
capture a user's image through said camera;
display said user's image within a casino-type game on said display screen.

11. The gaming device of claim 10, wherein said casino-type game is a slot game.

12. The gaming device of claim 11, wherein said user's image is displayed on a reel of said slot game.

13. The gaming device of claim 10, wherein said casino-type game is a bingo game.

14. The gaming device of claim 10, wherein said casino-type game is a poker game.

15. The gaming device of claim 14, wherein said memory storing program instructions, when executed by said processor, causes said processor to determine whether said user's image be placed on a king or jack card or a queen card.

16. The gaining device of claim 10, wherein said memory storing program instructions, when executed by said processor, causes said processor to alter said user's image captured by said camera through modifications received through said input device

17. The gaming device of claim 10, wherein said display screen includes touchpad capabilities.

18. A method of dynamically enhancing a casino game comprising:
identifying whether a player is within a defined area of said casino game;
taking a picture of said player when said player is within said defined area;
storing said picture within a vector art file; and
displaying said casino game that points to said vector art file for filling in portions of said casino game with said picture.

19. The method of claim 18, wherein said casino game is a slot game and said picture fills in a portion of at least one reel.

20. The method of claim 18, wherein said casino game is a bingo game and said picture is used as a daub.
